(19) United States
(12) Patent Application Publication
(10) Pub. No.: US 2006/0205845 A1
(43) Pub. Date: Sep. 14, 2006

(54) Depolymerization method and device

(75) Inventors: Egbert Schola, Baden (AT); Mojmir Ruzicka, Wien (AT)

Correspondence Address: OBLON, SPIVAK, MCCLELLAND, MAIER & NEUSTADT, P.C., 1940 DUKE STREET, ALEXANDRIA, VA, 22314, US

(73) Assignee: ROEHM GBMH & CO. KG, Darmstadt (DE)

(21) Appl. No.: 10/559,075

(22) PCT Filed: Mar. 20, 2004
(86) PCT No.: PCT/EP04/02954

§ 371 Date: Mar. 30, 2006

(51) Int. Cl. C08K 7/16; C09B 67/00

(52) U.S. Cl. 523/223; 523/330

(57) ABSTRACT

The invention concerns the recovery of monomeric esters of substituted or unsubstituted acrylic acid or of monomers containing styrene from polymer material (66) containing corresponding structural units. According to the invention, the polymer material is brought into contact with a heat transfer medium inside a heated reactor (51). The heat transfer medium and the polymer material (66) are agitated inside the reactor (51), and gas, which forms inside the reactor (51) and which contains the monomer, is drawn out of the reactor (51). The heat transfer medium contains a multitude of spherical particles (67), which has been proven to be particularly advantageous for achieving high yields and purity of the monomer to be recovered.

The invention relates to a process and an arrangement for recovery of monomeric esters of substituted or unsubstituted acrylic acid, of styrene and/or of monomeric styrene derivatives from polymer material comprising corresponding structural units.

Acrylate polymers, among which is acrylic sheet manufactured mainly from polymethyl methacrylate (PMMA), are used inter alia for production of long-life consumer products. To this end, molding processes are often utilized, and waste polymer is produced during their course. A treatment process is useful not only for this reason but also for recycling of used polymers. Similar considerations apply to polystyrene and to styrene-containing copolymers and their treatment. Acrylate polymers, especially PMMA, polystyrene, and styrene-containing copolymers can advantageously be broken down again completely at certain temperatures and pressures to give corresponding monomers.

The introduction to the description of DE 198 43 112 A1 describes a continuous process for PMMA depolymerization in which the comminuted plastic is passed into a hot extruder in which two tightly inter-meshing screws rotate with self-cleaning action. The thermal and mechanical shear in the extruder cause depolymerization of the PMMA. The resultant methyl methacrylate (MMA) is drawn off in the gas phase by way of a vent dome and condensed. The MMA content in the condensate in this process varies from 89 percent to 97 percent, and the yield of MMA is smaller than 97 percent. The heating of the PMMA in the extruder in that process takes place by way of jacket walls. However, as reactor volume increases, the ratio between jacket area (and therefore heatable wall area) and reactor volume to be heated becomes poorer. For large systems on an industrial scale, therefore, very high wall temperatures are required or reduced yield has to be expected. High wall temperatures can lead to local overheating which in turn can lead to formation of undesired by-products which impair the purity of the monomer.

It is moreover likewise known from the introduction to the description of DE 198 43 112 A1 that PMMA can be depolymerized by means of fluidized-bed pyrolysis. The fluidization material used is quartz sand of grain size from 0.3 to 0.7 mm. However, a plant with complicated flow technology is required to maintain fluidized-bed flow.

DE 198 43 112 A1 proposes bringing the polymer material into contact with hot mechanically fluidized solid (heat-transfer medium) in a reactor and drawing off and condensing the resultant vapor. In this process, the previously heated heat-transfer medium is continuously fed at one end of the reactor and the cooled heat-transfer medium is discharged at the other end. The heat-transfer media used comprise inorganic fine-particle solids whose grain size is from 0.1 to 5 millimeters or naturally occurring or synthetically produced oxides based on silicon, aluminum, magnesium, or zirconium, or else mixtures composed of these elements.

That process therefore requires heating equipment separate from the reactor and equipment for charging and discharging of the heat-transfer medium into the reactor and, respectively, out of the reactor. The discharge of the heat-transfer medium out of the reactor also has to be coordinated with the residence time of the polymer material and therefore with the dynamics of the depolymerization process, in order to obtain the desired yield of monomer.

It is an object of the present invention to provide a process and an arrangement for recovery of monomeric esters of substituted or unsubstituted acrylic acid, of styrene and/or of monomeric styrene derivatives from polymer material comprising corresponding structural units, where these permit, with very low process-technology costs, achievement of effective heat transfer to the polymer material and achievement of substantially homogeneous temperature distribution at least in subregions of the reactor space.

In the inventive process, the polymer material is brought into contact with a heat-transfer medium in a heated reactor, the heat-transfer medium and the polymer material are moved in the reactor, and gas which comprises the monomer and is produced in the reactor is drawn out of the reactor. Surprisingly, it has been found that the depolymerization process leads to good results even without complicated fluidized-bed technology, if the heat-transfer medium comprises a large number of spherical particles.

Accordingly, it is proposed that this large number of spherical particles be provided in a heatable reactor to produce the monomer gas in the inventive arrangement. A displacer is present here in order to move firstly the spherical particles and secondly the material to be moved, comprising the polymer material, in the reactor.

The reason for the surprising action of the spherical particles on the depolymerization process is probably that, in comparison with particles of other shapes, the spheres can slip with particular ease with respect to one another, with respect to surfaces of the reactor and of any equipment arranged therein (e.g. heating system and/or displacer) and with respect to the polymer material, and therefore mix particularly well with each other and with portions of the polymer material. It is therefore possible to achieve effective heat transfer from the heating system to the polymer material and substantially homogeneous temperature distribution at least in subregions of the reactor space.

As far as the size of the spheres is concerned, it has proven advantageous in experiments for the diameter to be in the range from 0.075 to 0.25 mm, preferably in the range from 0.1 to 0.2 mm. Within this size range, each sphere firstly retains considerable thermal capacity for the depolymerization process and secondly has particular ease of slip—like a particle of a fluid.

Various designs of the displacer are possible. In particular, use can be made of any of the variants familiar to the person skilled in the art, e.g. moving or rotating walls or other moving portions of the reactor. The displacer can, by way of example, also have one portion or two or more portions which execute a mechanical vibration and/or a tenuous linear (or non-linear) motion, thereby producing and/or maintaining motion of the material to be moved in the reactor. Preferred displacers have one or more rotating shafts in particular provided with mixing elements curved in the manner of a paddle and/or with other mixing elements. The shaft(s) can extend horizontally or vertically, for example. By way of example, a reactor which has a mixing system with shaft running vertically to which at least one mixing element protruding in the radial direction of the shaft has been secured is advantageous for a good mixing result. This embodiment permits continuous motion of at least one portion of the material to be moved, and, because the particles here are spherical, the material to be moved is subjected to continuous mixing motion.

The spherical particles preferably remain in the reactor during the depolymerization process and are not—as described in DE 198 43 112 A1—fed at one end of the reactor and discharged at an opposite end. The process is considerably simplified by their retention in the reactor. The process described in DE 198 43 112 A1 of relatively complicated and wasteful heating of the heat-transfer medium outside of the reactor can also be eliminated here (in which connection see the following paragraph). However, the invention is not restricted to retention of the spherical particles in the reactor. Other embodiments of the invention can also easily achieve better mixing than with conventional heat-transfer medium, or the same level of mixing by simpler means. In particular, lower drive energy levels and a correspondingly lower-power displacer, and lower heating power are sufficient. Local overheating with the abovementioned adverse effects is eliminated.

In one preferred embodiment, the reactor, or at least portions of the reactor, is/are heated directly, preferably electrically. By way of example, an area which is part of an outer wall of the reactor and which faces inward toward the reactor interior is heated, and/or at least one portion of a displacer arranged in the reactor is heated. In particular, at least one portion of the reactor or within the reactor has been connected to a heating system in a thermally conductive manner, and this portion in turn comes into contact with some of the spherical particles during the procedure for moving these particles. Good heat transfer to the polymer material is thus achieved with the aid of the particles.

If the polymer material comprises acrylic compounds, the average temperature of the particles of the heat-transfer medium in the reactor is in particular in the range from 250 to 600 degrees Celsius, and for recovery of MMA it is preferably below 425° C., the auto-ignition temperature of MMA. Experiments explained at a later stage below have shown that the inventive process can achieve high yields and likewise high purity of the monomer even at these low temperatures.

In one embodiment of the inventive process, the polymer material is heated and depolymerized during its residence time in the same reactor. There is no requirement here—as for example disclosed in DE 31 46 194 A1—to preheat the polymer material in a heating space upstream of the actual reactor space, because the spherical particles permit particularly rapid heat transfer from the heat source to the polymer material, and because particularly uniform temperature distribution can be achieved.

However, the invention is not restricted to this single-stage heating process. Indeed, by way of example, the polymer material may be introduced after preheating in a feed vessel allocated to the reactor or introduced after preheating in this type of feed vessel.

The spherical particles are preferably composed of a material not reactively involved in the recovery of the monomer. This can simplify or even eliminate treatment of the heat-transfer medium. By way of example, steel has good suitability as material for the spherical particles. Particular preference is given to stainless steel, in particular chromium- and nickel-containing steel, such as 18/10 Cr/Ni steel (V2A steel) or 17/12/2 Cr/Ni/Mo steel (V4A steel). Even standard steel has excellent elasticity, and—given appropriate mechanical excitement via the displacer—easy slip is also combined with saltation of the individual particles, and this accelerates heat distribution. Another reason for the particularly good suitability of stainless steel as material is that it is resistant to chemical reactions with a wide variety of the substances introduced into the reactor in the polymer material or together with the polymer material. Spheres composed of V2A steel or V4A steel can moreover be produced at low cost.

The depolymerization process preferably takes place in an inert-gas atmosphere, e.g. in a nitrogen atmosphere. The pressure in the reactor here can be ambient pressure (generally the same as the pressure of the earth's atmosphere) or below or above ambient pressure. If superatmospheric pressure is used, this is by way of example up to 133.3 hPa (100 torr). Although the invention also encompasses higher superatmospheric pressures, in practice they imply higher costs for technical equipment. The superatmospheric pressure is preferably in the range from 50 to 80 hPa (from 37.5 to 60 torr), in particular from 65 to 70 hPa (from 48.75 to 52.5 torr). If subatmospheric pressure is used this can by way of example be from 80 to 133.3 hPa (from 60 to 100 torr) below ambient pressure. Here again, higher pressures (i.e. lower absolute pressures) are possible.

In one particular embodiment of the invention, airlock equipment is provided for introduction of the polymer material into the reactor, and this airlock equipment comprises an airlock chamber. There is, furthermore, a first closure arranged at an input side of the airlock chamber and a second closure arranged at an output side of the airlock chamber. Evacuation equipment and gas-charge equipment have been combined with the airlock chamber so that when the first and second closure have been closed, it is possible to evacuate gas from the airlock chamber and to charge an inert gas to the airlock chamber. In this way it is possible, repeatedly and respectively, to introduce an amount of polymer material into the airlock chamber while the first closure is open, evacuate the airlock chamber, pass the inert gas into the airlock chamber, and then, after opening of the second closure, introduce the polymer material into the reactor.

Because the location of the polymer material even immediately before it is introduced into the reactor is in an inert-gas atmosphere, no direct charging of inert gas to the reactor is needed. In particular, this permits better insulation of the reactor with respect to heat losses.

The invention is described in more detail below by way of example on the basis of the attached drawing. However, there is no restriction of the invention to the inventive examples. The individual figures of the drawing are diagrams showing:

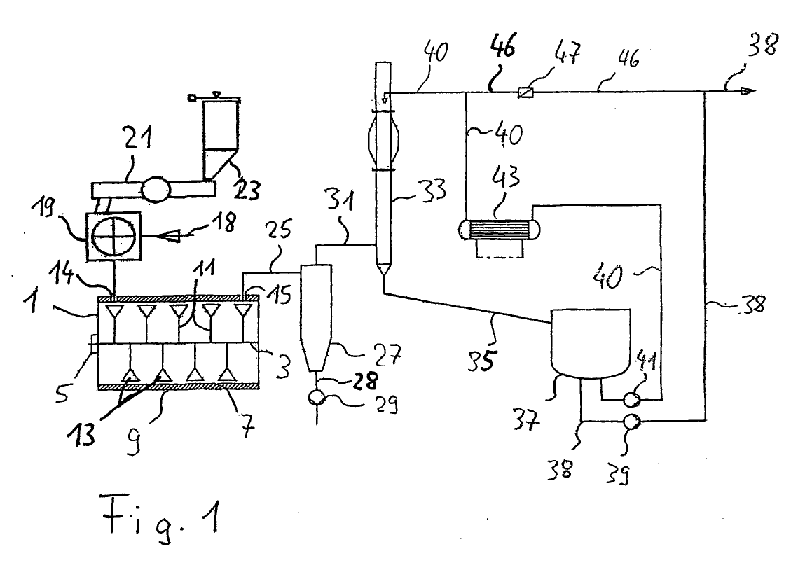

FIG. 1 a plant for recovery of monomeric substances from polymer material,

FIG. 2 a heated reactor for production of gas comprising monomer from the polymer material, from above,

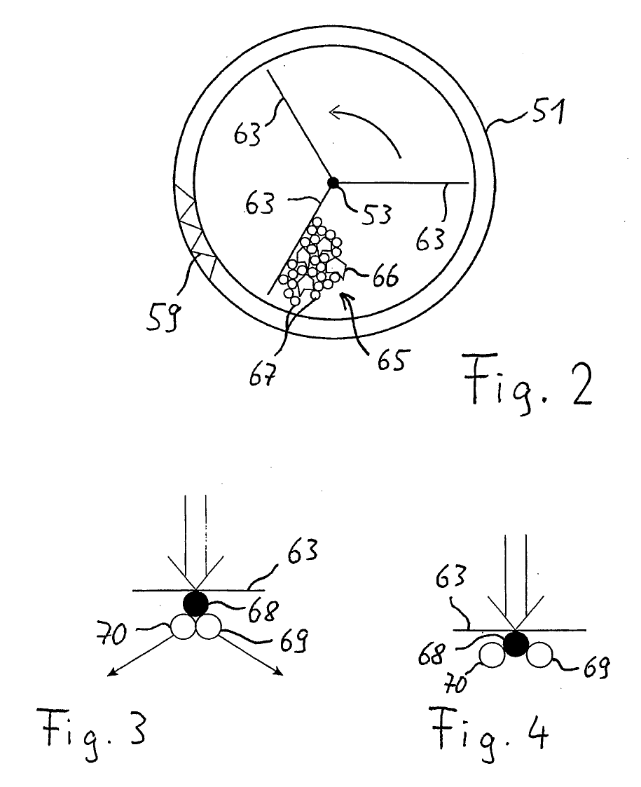

FIG. 3 an arrangement of spherical particles which are moved by a mixing element,

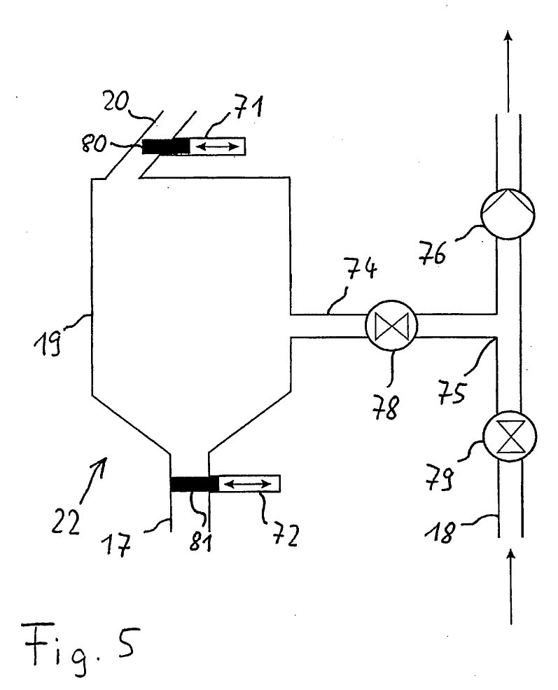

FIG. 4 the arrangement as in FIG. 3 at a later juncture of the motion and

FIG. 5 airlock equipment which by way of example has been installed upstream of the reactor shown in FIG. 1 and serves for passing polymer material into the reactor via an airlock.

The plant shown in FIG. 1 serves by way of example for depolymerization and recovery of MMA. However, it can—if appropriate with suitable adjustment of the pressure and of the temperature in a reactor 1 of the plant—alternatively be used for recovery of other monomeric esters of substituted or unsubstituted acrylic acid, of styrene and/or of monomeric styrene derivatives.

The plant described below is, as previously mentioned, an inventive example. One or more constituents of the plant can be replaced by other constituents. In particular, the method of introduction described below of the polymer material into the reactor can be varied, as can the reactor itself and/or the treatment of the monomer gas drawn off from the reactor.

The location of the polymer material to be depolymerized is in a feed vessel 23, whose outlet has attached metering equipment 21. The polymer material passes by way of the metering equipment 21 into an airlock chamber 19. An example of airlock equipment is explained in more detail using FIG. 5. The airlock equipment and airlock chamber 19 serve to pass the polymer material into the reactor 1 via an airlock, so that the depolymerization procedure can take place in an inert-gas atmosphere.

The polymer material is introduced into the reactor 1 by way of a charging aperture 14 of the reactor 1. The reactor 1 illustrated in FIG. 1 is a heated reactor with a continuously driven shaft 3 oriented horizontally, from which a large number of arms 11 protrude in the radial direction of the shaft 3. On that end of the arms 11 opposite to the shaft 3 there is in each case a mixing element 13 arranged, which by way of example has a triangular shape as illustrated in cross section. The mixing elements, which can also be regarded as including the arms, can also have a different design, e.g. a paddle shape and/or a large number of mixing elements attached at the end of each arm. A suitable mixing element is selected as a function of the nature and size of the spherical particles used (heat-transfer media) and/or as a function of the nature and size of portions of the polymer material. By way of example, the polymer material can be treated in various ways prior to introduction into the reactor, in particular comminuted into varying-size pieces and/or shapes. A familiar and suitable process is shredding of relatively large portions of the polymer material to give pieces with dimensions of from relatively few millimeters to two or more centimeters. Because the particles are spherical, the depolymerization process can proceed with good yields and with high purity using different sizes and shapes of the polymer material.

FIG. 2 shows an alternative design of the reactor, namely a reactor 51 with a vertically oriented rotating shaft 53 and with a plurality (in this case three) of paddle-shaped mixing elements 63 directly attached to the shaft 53 and protruding radially from the shaft 53. The straight-line representation of the mixing elements 63 is to be interpreted diagrammatically. Embodiments can have vertical and/or horizontal non-linearity of the mixing element 63.

FIG. 2 shows a material 65 to be moved by the mixing elements 63 with pieces of polymer material 66 and spheres 67 (for reasons of clarity of presentation only in one of the three sectors divided by the mixing elements 63 in the reactor 51). The shape of the spheres 67 enables them to move easily with respect to one another and relative to the pieces of polymer material 66. No mechanical interlocking or sticking therefore takes place within the material 67 to be moved. In order to ensure particularly good motion within the material to be moved, it is preferable that the total volume of the spheres in the reactor is greater than the total volume of the remaining solid pieces of polymer material, in particular at least twice as great. This very substantially eliminates caking or interlocking of the pieces of polymer material.

It is also preferable to use spheres composed of stainless steel, because particularly in the case of PMMA there is then no caking of the polymer material on the spheres. However, the high level of freedom of motion of the spheres always helps to prevent the polymer material from caking on the mixing elements, on other portions of the displacer and/or on the reactor walls.

As indicated in FIG. 2, the reactor 51 has an electrical heating system 59 at least on the reactor side wall. The reactor side walls and the base are preferably heated over substantially their entire surface and/or by means of heating equipment uniformly distributed across the wall area. By way of example, a conventional electrical resistance heating system and/or inductive heating equipment can be used, not only in this specific example.

In the case of the reactor 1 illustrated in FIG. 1, the outer jacket, by way of example circular, of the reactor 1 is heated over its entire surface via heating equipment 9. In order to obtain good long-term running properties of the shaft 3, the shaft 3 can be combined with a shaft cooling system 5.

The mixing motion and the spheres present in the reactor 1 cause heating and depolymerization of the polymer material in the reactor 1 in a short time. The time typically needed for complete conversion of a piece of PMMA to the monomeric gas phase is in the range from five to sixty seconds, depending on the average sphere temperature.

The gaseous MMA is drawn off via a gas aperture 15 of the reactor 1 and via monomer gas line 25 into a separator 27 in which additives, e.g. color pigments, are added. As shown in FIG. 1, the separator 27 is in particular a cyclone. The additives can be drawn off from the separator 27 by means of a pump 29 by way of a draw-off line 28. Inert gas (here nitrogen) also passes into the separator 27 alongside the MMA and the additives. The inert gas is subsequently separated from the MMA or drawn off together with the MMA.

The MMA/inert gas mixture is passed by way of a connecting line 31 into a cooler 33 (for example a quencher), in which a portion of previously cooled and returned condensate is sprayed as in a shower by means of a nozzle onto the gas mixture, which is still hot, thus cooling the gas mixture in a very short time. This can further increase the yield and purity of the monomer. This markedly reduces the level of solid deposits which can be produced on other conventional coolers. For the return process, the cooler 33 has been connected by way of a monomer draw-off line 35 to a monomer container 37 into which the cooled monomer is drawn off. A portion of the monomer located in the monomer container 37 is returned by means of a pump 41 to the nozzle of the upper apparatus by way of a return line 40. There is a continuous cooler 43 located in the return line 40.

The monomer is drawn off from the plant by way of another line 38 attached to the monomer container 37, driven via a pump 39. Additional return to the cooler 33 is possible via a connector line connected to the line 38 and capable of shut-off by means of a valve 47. For this purpose, the other end of the connector line 46 has been connected to that portion of the return line 40 which is located on the other side of the continuous cooler 43 in the direction of flow. The resultant temperature at the nozzle of the cooler 33 can be controlled by way of control of the valve 47 and corresponding mixing of returned monomer of varying temperature.

FIG. 3 and FIG. 4 again illustrate a substantial effect of the inventive spherical shape of the heat-transfer-medium particles. As indicated via a two-line arrow pointing downward in the illustration, a sphere 68 adjacent to a mixing element 63 is moved and transfers the motion to two other spheres 69, 70 adjacent to it. The resultant motion of the spheres 69, 70 has been shown via two arrows. The result is that the spheres 69, 70 are pushed apart with very little resistance to motion and permit easy passage of the sphere 68 (as shown in FIG. 4). Corresponding motion of the spheres is also possible relative to pieces of polymer material with similarly low resistance to motion.

FIG. 5 shows airlock equipment 22 which by way of example in the arrangement of FIG. 1 can be installed upstream of the reactor 1. A filler neck 20, which by way of example is attached to the metering equipment 21 shown in FIG. 1, opens into the airlock chamber 19 of the airlock equipment 22. The arrangement has, at the input side of the airlock chamber 19, a first closure, in the example an upper closure, which in the inventive example of the airlock equipment 22 shown can close the filler neck 20 by means of a closure component 80 capable of forward and backward motion. The design of the closure 71 is generally such that it can provide gas-tight sealing of the airlock chamber on the input side. On the output side of the airlock chamber 19, in this case below the airlock chamber, there is a second closure 72 which likewise by way of example can, by way of a closure component 81 capable of forward and backward motion, close a polymer line 17 to the reactor. The design of the second closure 72 is also such that it can provide gas-tight closure of the container 19 (in this case on the output side).

Attached to the airlock chamber 19 there is moreover a gas line 74, combined with a main valve 78. On that side of the main valve 78 opposite to the airlock chamber 19 there is a T piece 75 at which the gas line 74 branches into an upper branch and a lower branch. The arrangement has a pump 76 in the upper branch. The arrangement has an inert-gas valve 79 in the lower branch. The lower branch opens by way of example into the inert-gas feed line shown in FIG. 1. The upper and the lower branch do not have to lead upward and, respectively, downward as shown in the figure, but can lead in any suitable direction.

During the depolymerization procedure, in particular during operation of the plant shown in FIG. 1 or of another plant, an amount of polymer material is repeatedly charged to the reactor. For this purpose, the amount of polymer material is first charged via the filler neck 20 into the airlock chamber 19. The second, lower closure 72 has been closed here. Once the polymer material has been introduced, the first, upper closure 71 is also closed. The main valve 78 is then opened (unless it is already open), and gas (in particular air) is evacuated from the airlock chamber 19 by means of the pump 76. The inert-gas valve 79 has been closed here. The pump 76 is then switched off and, if necessary, the upper branch of the gas line 74 is also shut off. Inert gas is then moreover passed into the airlock chamber 19 while the main valve 78 and the inert-gas valve 79 have been opened, until a desired pressure has been reached. The final pressure reached here in the airlock chamber 19 is preferably higher than the pressure of the inert gas in the reactor. This can firstly compensate for inert gas losses from the reactor via draw-off of the monomer/inert gas mixture from the reactor and can secondly inhibit escape of the monomer/inert gas mixture via the polymer feed line into the airlock chamber 19.

Once the final pressure has been reached in the airlock chamber 19, the second, lower closure 72 is opened and the amount of polymer material is thus introduced into the reactor.

Experimental examples for design and execution of the depolymerization procedure in a reactor are now described below.

### EXAMPLE 1

A paddle reactor of diameter 280 mm and length 400 mm was selected. Twelve kilograms of steel spheres of diameter 0.2 mm were charged as heat-transfer medium to this reactor. During the depolymerization process, the average temperature of the spheres was 456 degrees Celsius, and the superatmospheric pressure of the inert gas in the reactor (nitrogen in the example) was 66.7 hPa (about 50 torr), based on the pressure of the earth's atmosphere at sea level, and the rotation rate of the shaft of the paddle reactor was 100 rpm. An MMA yield of 97% with purity of 98.5% was achieved using the plant structure as shown in FIG. 1.

### EXAMPLE 2

The procedure corresponded to that of example 1, but twenty kilograms of the steel spheres were charged to the reactor and the average temperature of the spheres was set at 380 degrees Celsius. MMA yield was 98% with purity of 99%.

### EXAMPLE 3

The experiment was carried out as described in example 2, but the process was run with an average temperature of only 320 degrees Celsius for the spheres. MMA yield was 98.5% with purity of 99%.

What is claimed is:

1. A process for recovery of monomeric esters of substituted or unsubstituted acrylic acid, of styrene and/or of monomeric styrene derivatives from polymer material comprising corresponding structural units, where
the polymer material is brought into contact with a heat-transfer medium in a heated reactor (1; 51),
the heat-transfer medium and the polymer material are moved in the reactor (1; 51) and
gas which comprises the monomer and is produced in the reactor (1; 51) is drawn out of the reactor (1; 51),
where the heat-transfer medium comprises a large number of spherical particles (67).

2. The process as claimed in claim 1, where the polymer material comprises acrylic compounds and where the average temperature of the particles (67) of the heat-transfer medium in the reactor (1; 51) is in the range from 250 to 600 degrees Celsius.

3. The process as claimed in claim 1 or 2, where the reactor (1; 51) is electrically heated.

4. The process as claimed in any of claims 1 to 3, where the spherical particles (67) are composed of a material not reactively involved in the recovery of the monomer.

5. The process as claimed in claim 4, where the spherical particles (67) are composed of stainless steel, in particular of chromium- and nickel-containing steel.

6. The process as claimed in any of claims 1 to 5, where the diameter of the spherical particles (67) is in the range from 0.075 to 0.25 mm, in particular in the range from 0.1 to 0.2 mm.

7. The process as claimed in any of claims 1 to 6, where the spherical particles (67) are moved via a continuously driven mixing element and remain in the reactor (1; 51).

8. The process as claimed in any of claims 1 to 7, where the polymer material and the spherical particles are moved in an inert-gas atmosphere.

9. The process as claimed in any of claims 1 to 8, where the location of the polymer material immediately before it is introduced into the reactor (1; 51) is in an inert-gas atmosphere.

10. An arrangement for recovery of monomeric esters of substituted or unsubstituted acrylic acid or of monomers comprising styrene from polymer material comprising corresponding structural units, where the arrangement comprises the following:
a heatable reactor (1; 51) to produce, from the polymer material, gas comprising the monomer and
a displacer (3, 11, 13; 53, 63) which has been combined with the reactor (1; 51) or which is a portion of the reactor, and which is intended to move material (65) to be moved present in the reactor (1; 51),
where the material (65) to be moved comprises the polymer material and a heat-transfer medium, and where the heat-transfer medium comprises a large number of spherical particles (67).

11. The arrangement as claimed in claim 10, characterized by airlock equipment (22) for introduction of the polymer material into the reactor (1; 51), where the airlock equipment (22) comprises an airlock chamber (19), a first closure (71) arranged at an input side of the airlock chamber (19), and a second closure (72) arranged at an output side of the airlock chamber (19), and where evacuation equipment (74, 75, 76) and gas-charge equipment (18, 74, 75, 79) have been combined with the airlock chamber (19) so that when the first and second closure (71, 72) have been closed it is possible to evacuate gas from the airlock chamber (19) and to charge an inert gas to the airlock chamber (19).
